(19) United States
(12) Patent Application Publication
(10) Pub. No.: US 2011/0025257 A1
(43) Pub. Date: Feb. 3, 2011

(54) CIRCUIT FOR EXTRACTING POWER FROM A BATTERY AND AN ELECTRONIC APPARATUS COMPRISING THE CIRCUIT

(76) Inventor: Lin-Song Weng, Chu-Pei City (TW)

Correspondence Address: BIRCH STEWART KOLASCH & BIRCH, PO BOX 747, FALLS CHURCH, VA, 22040-0747, US

(21) Appl. No.: 12/607,652

(22) Filed: Oct. 28, 2009

(30) Foreign Application Priority Data
Jul. 28, 2009 (TW) 098213768

(51) Int. Cl. H02J 7/00

(52) U.S. Cl. 320/103; 307/43

(57) ABSTRACT

The present invention provides a circuit for extracting power from a battery and an electronic apparatus comprising the circuit. The circuit of the invention includes a first connecting unit, a second connecting unit and a processor. The first connecting unit is used for connecting a dry battery, and the second connecting unit is used for connecting a rechargeable battery. Additionally, the processor is connected to the first connecting unit and the second connecting unit respectively, for controlling the dry battery to charge the rechargeable battery, and for controlling the rechargeable battery to supply power to a load.

### FIELD OF THE INVENTION

The present invention is correlated with one battery power extraction circuit and one electronic device comprising this battery power extraction circuit.

### BACKGROUND OF THE INVENTION

Fast developed electronic-related technologies have made many small, exquisite, and easily-portable electronic products such as mobile phone, digital camera, laptop, multimedia player, etc., existing in our daily lives and changing our life styles. For the sake of facilitating a user to use these gadgets anytime at every place, these electronic products can be recharged with batteries in general.

Batteries frequently employed right now are nothing more than dry battery, alkaline battery, rechargeable battery, and lithium cell wherein a dry battery has carbon, zinc, and zinc chloride as its major components, an alkaline battery has zinc and manganese as its major components, and a rechargeable battery has nickel, cadmium, zinc, manganese, lithium, and hydrogen as its major components. Despite several benefits such as inexpensive, easily available, and applicable extensively, a dry battery has shorter operation time because of its smaller current.

While used for a period, a dry battery will generate power insufficient in virtue of its gradually-ascending internal resistance caused by chemical changes in its components. In addition, a dry battery's different remaining power might come from this battery applied in different products with different loads. For one product with its load greater than remaining power of one battery (or batteries), power is not continuously supplied from one battery (or batteries) which will be regarded as power exhausted and replaced by one user.

Without a repeatedly-used characteristic, lots of used old dry batteries have caused significant pollution in environments. With some power remained in particular, most abandoned dry batteries have led to a user's intangible waste or resource waste of one society.

### SUMMARY OF THE INVENTION

Against this background, the present invention has one objective to provide one battery power extraction circuit to solve problems existing in the prior art.

According to one embodiment, a battery power extraction circuit comprises one first connecting unit linking one dry battery, one second connecting unit linking a rechargeable battery, and one processor linking both the first connecting unit as well as the second connecting unit. In particular, this processor can control the dry battery to charge the rechargeable battery which supplies power to one load.

The objective of this invention is to provide one electronic device which solves the previous technical problem.

According to one embodiment, the electronic device comprises one battery power extraction circuit. As previously mentioned, the battery power extraction circuit comprises one first connecting unit linking one dry battery, one second connecting unit linking one rechargeable battery, and one processor linking both the first connecting unit as well as the second connecting unit. In particular, this processor can control the dry battery to charge the rechargeable battery which supplies power to the electronic device.

With the following detailed descriptions and attached figures, advantages and essences correlated with this invention can be further realized.

### BRIEF DESCRIPTION OF THE DRAWINGS

FIG. 1 is the block diagrams for functions the battery power extraction circuit in one embodiment of this invention;

FIG. 2 is the block diagrams for functions the battery power extraction circuit in one embodiment of this invention;

FIG. 3 is the block diagrams for functions the battery power extraction circuit in one embodiment of this invention;

FIG. 4 is the diagram of an electronic device in one embodiment of this invention; and

FIG. 5 is the diagram of an electronic device in one embodiment of this invention.

### DETAILED DESCRIPTION OF THE PREFERRED EMBODIMENTS

The present invention provides one battery power extraction circuit and one electronic device comprising this battery power extraction circuit. The invention's embodiment and its realistic applications specified below will completely interpret characteristics, essences, and advantages of this invention.

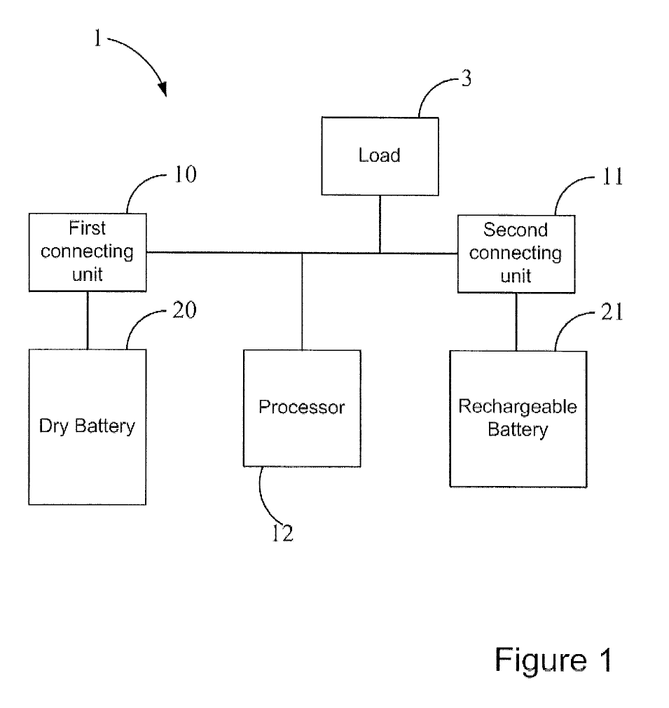

Refer to FIG. 1 which indicates block diagrams for functions the battery power extraction circuit in one embodiment of this invention. As shown in this figure for the embodiment, the battery power extraction circuit 1 comprises one first connecting unit 10, one second connecting unit 11, and one processor 12.

The first connecting unit 10 is connected to one dry battery 20 and the second connecting unit 11 is connected to one rechargeable battery 21. In realistic applications, the first connecting unit 10 and the second connecting unit 11 contains one first electrode used to electrically connect with an anode and a cathode of the dry battery 20 and one second electrode used to electrically connect with an anode and a cathode of the rechargeable battery 21, respectively. Naturally, the first connecting unit 10 and the second connecting unit 11 also comprise plural first electrodes and plural second electrodes respectively which are used for connecting with serial-connected or parallel-connected anodes and cathodes of plural dry batteries 20 or plural rechargeable batteries 21 to develop one battery pack or one rechargeable pack circumstantially. Additionally, the first connecting unit 10 or the second connecting unit 11 in practical applications can include one housing with its front end and back end on which the first electrode and the second electrode previously mentioned are installed respectively. In this fashion, when the dry battery 20 and the rechargeable battery 21 are installed on the housing, anodes and cathodes of the dry battery 20 and the rechargeable battery 21 can be electrically linked to the housing's first electrode and second electrode, respectively.

Furthermore, one processor 12 connected to the first connecting unit 10 and the second connecting unit 11 can control the dry battery 20 to charge the rechargeable battery 21. With the rechargeable battery 21 totally charged, the rechargeable battery 21 can supply power to one load 3. In addition, the processor 12 can adjust power supplied to the load 3 from the rechargeable battery 21 according to the power consumed by the load 3.

In realistic applications, the processor 12 can be either one single-chip central processing unit, for instance, one single-chip central processing unit with functions of both Analog-to-Digital Converter (ADC) and Digital-to-Analog Converter (DAC), or other devices selected circumstantially.

It should be noted that the load 3, in general, might be an electronic device, an electronic product, or an electronic component with power required in operations supplies by one rechargeable battery. For instance, the load 3 for this invention can be a remote controller, a multimedia player, a flashlight, a toy, or appropriate equipment.

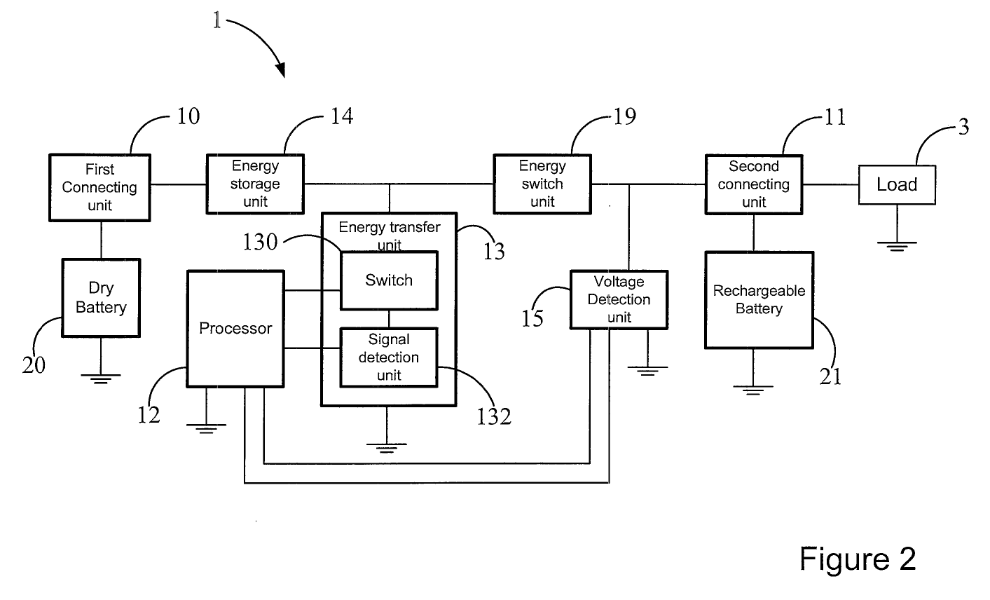

Refer to FIG. 2 which indicates block diagrams for functions the battery power extraction circuit in one embodiment of this invention. As shown in this figure, the battery power extraction circuit 1 comprises the first connecting unit 10, the second connecting unit 11, and the processor 12 mentioned previously. Additionally, the battery power extraction circuit 1 in this embodiment also comprises one energy transfer unit 13, one energy storage unit 14, one voltage detection unit 15, and one energy switch unit 19.

The energy transfer unit 13 comprises one switch 130, and one signal detection unit 132 wherein the former is connected to the first connecting unit 10, the second connecting unit 11, the processor 12, and the signal detection unit 132 and the latter is also connected to the processor 12. The energy transfer unit 13 is able to detect power supplying status of the dry battery 20 as well as the rechargeable battery 21 and transfer detected power supplying status to the processor 12 which can determine the status. For nonconforming power supplying status of the rechargeable battery 21 determined by the processor 12, the processor 12 will deliver one switching signal to the energy transfer unit 13 whose switch 130 can control power supplied to the load 3 by the dry battery 20 in accordance with the switching signal. In addition, the signal detection unit 132 is able to determine a switching status of the switch 130, that is, power supplied by the rechargeable battery 21 or the dry battery 20, and deliver the switching status to the processor 12. In practice, the switch 130 might be either a Metal Oxide Semiconductor Field Effect Transistor (MOSFET) switch or another appropriate switch.

The energy storage unit 14 is connected with the first connecting unit 10 and the second connecting unit 11 to improve stability of current supplied by the dry battery 20. In practical applications, the energy storage unit 14 can be either one inductor or another appropriate filter.

Linking the second connecting unit 11 as well as the processor 12, the voltage detection unit 15 can be used for detecting voltages of the rechargeable battery 21 and delivering detected results to the processor 12. In this fashion, the processor 12 can control positions of the switch 130 to be the dry battery 20 supplying power to the load 3 when voltages of the rechargeable battery 21 are unstable. Additionally, the energy switch unit 19 connected between the energy storage unit 14 and the second connecting unit 11 is used for controlling energy in the energy storage unit 14 delivered to the second connecting unit 11 and then to the rechargeable battery 21.

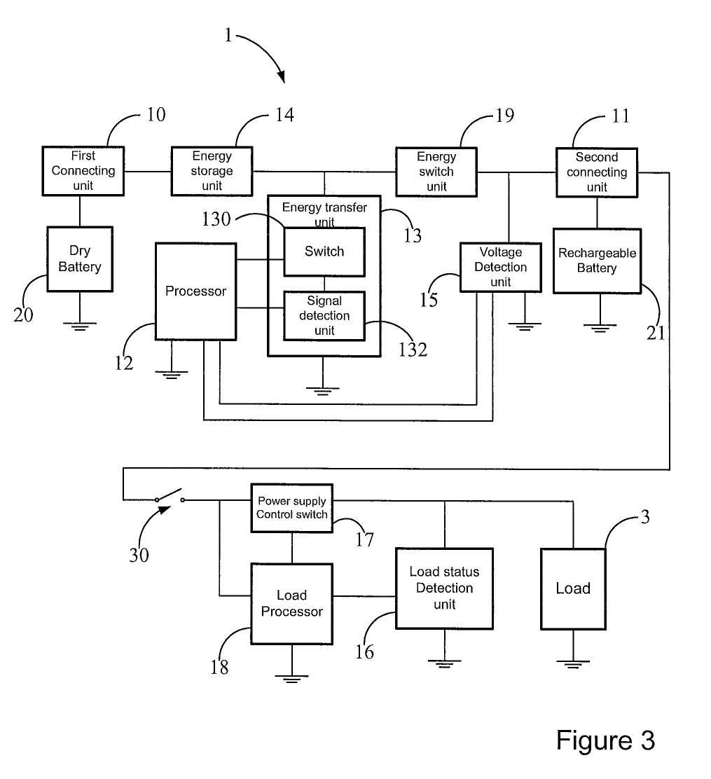

Refer to FIG. 3 which indicates block diagrams for functions the battery power extraction circuit in one embodiment of this invention. As shown in this figure, the battery power extraction circuit 1 comprises the first connecting unit 10, the second connecting unit 11, the processor 12, the energy transfer unit 13, the energy storage unit 14, the voltage detection unit 15, and the energy switch unit 19 which are mentioned previously. Furthermore, the power extraction circuit 1 in this embodiment also comprises one load status detection unit 16, one power supply control switch 17, and one load processor 18. Additionally, the load 3 also includes one power-on switch 30. The load status detection unit 16, the power supply control switch 17, the load switch 18, and the power-on switch 30 constitutes one control circuit.

It should noted in this embodiment that relationships and effects of the first connecting unit 10, the second connecting unit 11, the processor 12, the energy transfer unit 13, the energy storage unit 14, the voltage detection unit 15, and the energy switch unit 19 have been interpreted previously and not repeated here.

Further, the load detection unit 16 connected with the load 3 as well as the load processor 18 is used for detecting voltages of the load 3 and delivering detected results to the load processor 18. In practice, the processor 12 will communicate with the load processor 18 about information such as voltages of the load 3 for adjustable output power coming from the rechargeable battery 21 or the dry battery 20 and then supplied to the load 3 steadily and effectively. Furthermore, the processor 12 can be integrated with the load processor 18 to become one single processing component in realistic applications.

Besides, the process 12 connected to the power-on switch 30 of the load 3 can control the dry battery 20 to charge the rechargeable battery 21 and the rechargeable battery 21 to supply the load 3 power when the power-on switch 30 is turned to develop one closed circuit.

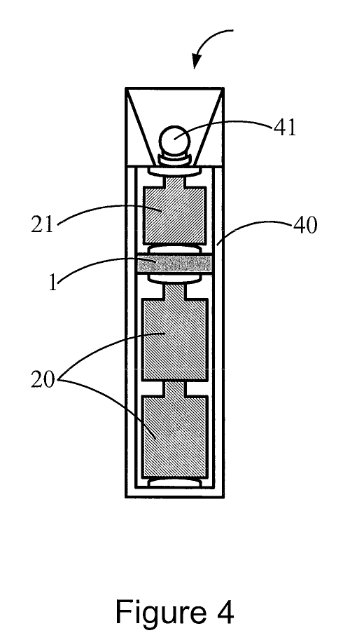

Refer to FIG. 4 which indicates the diagram of one electronic device in one embodiment of the invention. In this embodiment particularly, the electronic device is one flashlight 4 with one housing 40 used for holding the previously-mentioned battery power extraction circuit 1, two dry batteries 20, one rechargeable battery 21, and one light bulb 41.

As shown in this figure, the battery power extraction circuit 1 installed between the dry battery 2n and the rechargeable battery 21 is used for controlling power charged to the rechargeable battery 21 by the dry battery 20, so as to enable the rechargeable battery 21 to supply power to the light bulb 41. In practice, the battery power extraction circuit 1 can be regarded as one circuit shown in FIG. 1, FIG. 2, or FIG. 3 and covers all units and modules mentioned above. It should be noted that relationships and effects between these units and modules have been interpreted before and not repeated here.

In this embodiment, two dry batteries 20 are serial-connected; in realistic applications, plural dry batteries 20 are also parallel-connected. Besides, one rechargeable battery or more can be incorporated into the electronic device.

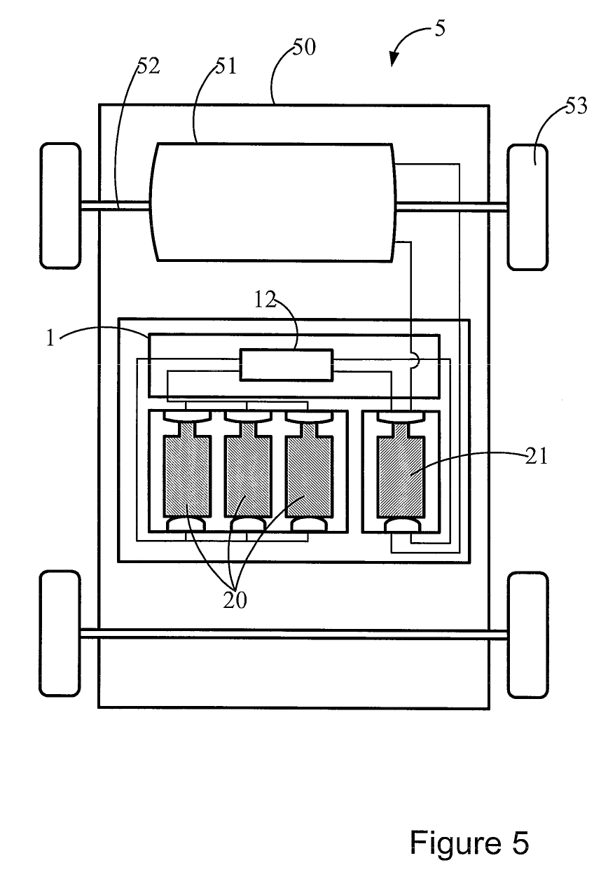

Refer to FIG. 5 which indicates the diagram of one electronic device in one embodiment of the invention. In this embodiment particularly, the electronic device is one electronic toy car 5 comprising one car body 50 and the above-mentioned battery power extraction circuit 1, dry batteries 20, and one rechargeable battery 21, which are installed on the car body 50. In addition, the electronic toy car 5 also comprises one motor 51, one wheel axle 51, and wheels 53.

As shown in this figure, this embodiment comprises three parallel-connected dry batteries 20 and one rechargeable battery 21. Furthermore, connected with the dry batteries 20 as well as the rechargeable battery 21, the processor 12 in the battery power extraction circuit 1 is used for controlling the dry batteries 20 to charge the rechargeable battery 21 which is able to supply power to the motor 51. Further, the driven motor 51 can drive the wheel axle 52 and then wheels 53 to be rotated.

Similarly, the battery power extraction circuit 1 of this embodiment can be one circuit in FIG. 1, FIG. 2, or FIG. 3 circumstantially and covers all above-mentioned units and modules. It should be noted that relationships and effects of these units and modules have been interpreted before but not repeated here.

In realistic applications, the electronic device of this invention can be any appropriate electronic product or component rather than just the previously-mentioned flashlight or electronic toy car.

With above descriptions summarized, the processor incorporated in the battery power extraction circuit of this invention has supplied not only a function of managing continuously-extracted power of dry batteries but also a function of managing one load's output. Furthermore, the idle battery power extraction circuit of this invention is able to extract dry batteries' electric quantity and control dry batteries to charge one rechargeable battery which can supply power to one load. In this fashion, the battery power extraction circuit of this invention will completely employ dry batteries' power to substantially materialize energy saving as well as carbon reduction with less battery pollution. Additionally, for various types of loads, the battery power extraction circuit of this invention is able to adjust output power of one rechargeable battery for power effectively-supplied and better energy-saving effects.

Although the present invention is disclosed through a better embodiment as above, yet it is not used to limit the present invention, anyone that is familiar with this art, without deviating the spirit and scope of the present invention, can make any kinds of change, revision and finishing; therefore, the protection scope of the present invention should be based on the scope as defined by the following attached “what is claimed”.

What is claimed is:

1. One battery power extraction circuit comprises:
One first connecting unit linking one dry battery;
One second connecting unit linking one rechargeable battery; and
One processor linking the first connecting unit as well as the second connecting unit controls the dry battery to charge the rechargeable battery which can supply power to one load.

2. The battery power extraction circuit according to claim 1 further comprises:
One energy transfer unit linking the first connecting unit, the second connecting unit, and the processor is used for detecting one first power supply status of the dry battery and one second power supply status of the rechargeable battery wherein the first power supply status as well as the second power supply status can be delivered to the process, which is able to send the energy transfer unit one switching signal so as to make the energy transfer unit control power supplied to the load by the dry battery according to the switching signal while determining one nonconforming second power supply status.

3. The battery power extraction circuit according to claim 2 wherein the energy transfer unit further comprises:
One switch linking the first connecting unit, the second connecting unit, and the processor can control the dry battery to supply the load power in compliance with the switching signal; and
One signal detection unit linking the switch and the processor is used for determining the switch's switching status and delivering the switching status to the processor.

4. The battery power extraction circuit according to claim 3 wherein the switch is one Metal Oxide Semiconductor Field Effect Transistor (MOSFET) switch.

5. The battery power extraction circuit according to claim 1 further comprises:
One energy storage unit linking the first connecting unit and the second connecting unit is used for improving stability of current supplied by the dry battery.

6. The battery power extraction circuit according to claim 1 further comprises:
One voltage detection unit linking the second connecting unit and the processor is used for detecting the rechargeable battery's voltages and delivering detected results to the processor.

7. The battery power extraction circuit according to claim 1 further comprises:
One load status detection unit linking the load and the processor is used for detecting the load's voltages and delivering detected results to the processor.

8. The battery power extraction circuit according to claim 1 wherein the processor further adjusts power supplied to the load by the rechargeable battery according to power consumed by the load.

9. The battery power extraction circuit according to claim 1 wherein the load further comprises one power-on switch and the processor controls the dry battery to charge the rechargeable battery with the power-on switch turned to develop one closed circuit.

10. The battery power extraction circuit according to claim 1 wherein the processor is one single-chip central processing unit.

11. One electronic device compromises:
One battery power extraction circuit comprising:
One first connecting unit linking one dry battery;
One second connecting unit linking one rechargeable battery; and
One processor linking the first connecting unit and the second connecting unit controls the dry battery to charge the rechargeable battery, so as to make the rechargeable battery supply power to the electronic device.

12. The electronic device according to claim 11 wherein the battery power extraction circuit further comprises:
One energy transfer unit linking the first connecting unit, the second connecting unit, and the processor is used for detecting the dry battery's first power supply status as well as the rechargeable battery's second power supply status and delivering the first power supply status as well as the second power supply status to the processor, which will send one switching signal to the energy transfer unit that can control the dry battery's power supplied to the electronic device according to the switching signal while determining one nonconforming second power supply status.

13. The electronic device according to claim 12 wherein the energy transfer unit further comprises:
One switch linking the first connecting unit, the second connecting unit and the processor is used for controlling the dry battery's power supplied to the load in compliance with the switching signal; and
One signal detection unit linking the switch and the processor is used for determining one switching status of the switch and delivering the switching status to the processor.

14. The electronic device according to claim 13 wherein the switch is one Metal Oxide Semiconductor Field Effect Transistor (MOSFET) switch.

15. The electronic device according to claim 11 wherein the battery power extraction circuit further comprises:
One energy storage unit linking the first connecting unit and the second connecting unit is used for improving stability of current supplied by the dry battery.

16. The electronic device according to claim 11 wherein the battery power extraction circuit further comprises:
One voltage detection unit linking the second connecting unit and the processor is used for detecting voltages of the rechargeable battery and delivering detected results to the processor.

17. The electronic device according to claim 11 wherein the battery power extraction circuit further comprises:
One load status detection unit linking the electronic device and the processor is used for detecting voltages of the electronic device and delivering detected results to the processor.

18. The electronic device according to claim 11 wherein the processor can further adjust power supplied to the electronic device by the rechargeable battery according to power consumed by the electronic device.

19. The electronic device according to claim 11 further comprises one power-on switch and its processor controls the dry battery to charge the rechargeable battery with the power-on switch turned to develop one closed circuit.

20. The electronic device according to claim 11 wherein the processor is one single-chip central processing unit.
